(19) United States
(12) Patent Application Publication
(10) Pub. No.: US 2026/0147793 A1
(43) Pub. Date: May 28, 2026

(54) METHOD TO IMPROVE LLM RAG QUERY RESULT

(71) Applicant: International Business Machines Corporation, Armonk, NY (US)

(72) Inventors: QIN YUE CHEN, Shanghai (CN); Han Su, Shanghai (CN); Fei Fei Li, Shanghai (CN); HONG WEI SUN, BEIJING (CN)

(21) Appl. No.: 18/956,069

(22) Filed: Nov. 22, 2024

(51) Int. Cl. G06F 16/332; G06F 16/33

(52) U.S. Cl. CPC G06F 16/3325; G06F 16/3334; G06F 16/3335

(57) ABSTRACT

A system includes a processor that executes computer executable components stored in a memory. The computer executable components can include a reception component that receives a query. The computer executable components can further include a contextualization component that contextualizes the query by identifying context of the query and summarizing background information of the query. The computer executable components can further include a keyword extraction component that uses a natural language processor to identify keywords of the contextualized query. Additionally, the computer executable components can include a refinement component that generates a new query based at least in part on the summarized background information and the extracted keywords. The computer executable components can further include an execution component that uses a retrieval-augmented generation system to run the new query.

### TECHNICAL FIELD

The subject disclosure relates to contextual query refinement for retrieval-augmented generation, e.g., improving the precision of information retrieval by refining query focus.

### BACKGROUND

Retrieval-Augmented Generation (RAG) is a method that leverages external knowledge sources to enhance the quality and relevance of responses generated by Large Language Models (LLMs). Retrieval-augmented generation is particularly useful knowledge-intensive Natural Language Processing (NLP) tasks like question-answering and abstract generation, as it allows large language models to access external knowledge without retraining for each unique task. In the retrieval-augmented generation process, prompts are initially provided to an index store for searching and the search results are used to perform queries.

Although useful, the retrieval-augmented generation process faces challenges when applied to large datasets containing extensive background context. Key information sought by the query can be buried within broader contextual data, leading the index store to return correlated background data instead of the precise information needed. Generating relevant responses to a retrieval-augmented generation query requires extensive manual intervention which can be time-consuming, error-prone, and resource-intensive, limiting scalability and efficiency in processing large datasets or complex queries.

### SUMMARY

The following presents a summary to provide a basic understanding of some embodiments of the invention. This summary is not intended to identify key or critical elements or delineate any scope of the particular embodiments or any scope of the claims. Its sole purpose is to present concepts in a simplified form as a prelude to the more detailed description that is presented later. In some embodiments described herein, systems, computer-implemented methods, and/or computer program products that facilitate contextual query refinement for retrieval-augmented generation.

According to an embodiment, a system can comprise a processor that executes computer executable components stored in memory. The computer executable components can comprise a reception component that receives a query. The computer executable components can further comprise a contextualization component that contextualizes the query by identifying context of the query and summarizing background information of the query. The computer executable components can further comprise a keyword extraction component that uses a natural language processor to identify keywords of the contextualized query. The computer executable components can comprise a refinement component that generates a new query based at least in part on the summarized background information and the extracted keywords. The computer executable components can further comprise an execution component that uses a retrieval-augmented generation system to run the new query.

According to another embodiment, a computer-implemented method can comprise receiving, by a system operatively coupled to a processor, a query. The computer-implemented method comprises contextualizing, by a system, the query by identifying context of the query. The computer-implemented method further comprises summarizing, by a system, background information of the query. The computer implemented method can further comprise identifying, by the system, keywords of the contextualized query. The computer implemented method can further comprise generating, by the system, a new query based at least in part on the summarized background. The computer implemented method can further comprise running, by the system, the query.

According to another embodiment, a computer program product comprising a computer readable storage medium having program instructions embodied therewith, the program instructions executable by a processor to cause the processor to receive, by the processor, the query. The program instructions can also cause the processor to contextualize, by the processor, the query by identifying a context of the query. The program instructions can also cause the processor to summarize, by the processor, background information of the query. The program instructions can further cause the processor to identify, by the processor, keywords of the contextualized query. The program instructions can cause the processor to generate, by the processor, a new query based at least in part on the summarized background information and the extracted keywords. The program instructions can also cause the processor to run, by the processor, the query.

### BRIEF DESCRIPTION OF THE DRAWINGS

FIGS. 1 and 2 illustrate example systems that can facilitate contextual query refinement for retrieval-augmented generation in accordance with some embodiments described herein.

FIGS. 3 and 4 illustrate flow diagrams of example computer implemented methods that can facilitate contextual query refinement for retrieval-augmented generation in accordance with some embodiments described herein.

FIG. 5 illustrates an example flow diagram that can facilitate contextual query refinement for retrieval-augmented generation in accordance with some of the embodiments described herein.

FIG. 6 illustrates a flow diagram of an example query contextualization and refinement system for retrieval-augmented generation in accordance with some of the embodiments described herein.

FIG. 7 illustrates a block diagram of an example computing environment in which some embodiments described herein can be facilitated.

### DETAILED DESCRIPTION

The following detailed description is merely illustrative and is not intended to limit embodiments, applications, and/or uses of embodiments. Furthermore, there is no intention to be bound by any expressed or implied information presented in the preceding Background or Summary sections, or in the Detailed Description section.

Traditional retrieval-augmented generation methodologies struggle to deliver precise results when processing substantial datasets containing layered contextual data. Current retrieval-augmented generation systems can inadvertently surface irrelevant background information, especially when important query terms or context-sensitive keywords are embedded within complex data. In such scenarios, the large language model's ability to generate a highly relevant response becomes compromised, as it relies on retrieved documents that may lack alignment with the query's true intent.

This system described introduces an advanced method to enhance query generation and document retrieval in the retrieval-augmented generation framework. By refining the large language model's query formulation and retrieval mechanisms, it enables the model to more accurately filter and prioritize information aligned with the query's intent, rather than merely correlated background data. This approach can significantly reduce the likelihood of irrelevant information surfacing in response to specific queries, thus enhancing the overall effectiveness and reliability of retrieval-augmented generation processes.

Through improved query formulation and contextualization techniques, the system ensures that keywords remain central to retrieval results, allowing the large language model to access and utilize the most pertinent information. This improvement not only minimizes manual intervention but also ensures that the model's responses are more directly aligned with query intent, which can increase the quality, accuracy, and efficiency of retrieval-augmented generation processes.

According to an embodiment, a system can include a processor that executes computer executable components stored in a memory. The computer executable components can include a reception component that receives a query. The computer executable components can further include a contextualization component that contextualizes the query by identifying context of the query and summarizing background information of the query. The computer executable components can further include a keyword extraction component that uses a natural language processor to identify keywords of the contextualized query. Additionally, the computer executable components can include a refinement component that generates a new query based at least in part on the summarized background information and the extracted keywords. The computer executable components can further include an execution component that uses a retrieval-augmented generation system to run the new query.

In some embodiments, the system can further comprise an artificial intelligence component that trains an artificial intelligence model to generate a new query. According to some embodiments, the artificial intelligence component can train an artificial intelligence model on the contextualized query and the extracted keywords to generate a new query to generate a new query.

In some embodiments, the reception component can further comprise a prompt template mechanism that includes one or more placeholders. The prompt template mechanism can use a predefined structure or format for queries designed to guide input in a consistent way.

In some embodiments, the contextualization component can distinguish the query from contextual knowledge and remove extraneous background information. The contextualization component can further identify a core question pertaining to the query.

According to an embodiment, upon identifying the core question pertaining to the query, the refinement component can generate a new query at least in part by blending the core question with the summarized information or extracted keywords. In other embodiments, upon generating a new query, the refinement component can utilize a generative model to blend the core question with the summarized information or extracted keywords. According to some embodiments, the refinement component can utilize a generative transformer model to reformulate the query.

In some embodiments, the keyword extraction component can utilize surrounding background information to mine essential keywords. In other embodiments, the identified keywords can comprise of contextual information.

Advantages of this system can include increased retrieval access by focusing, reduced information overload by filtering out extraneous data, and enhanced response quality by identifying the core question within complex queries.

According to some embodiments, the above-described computer system may be implemented as a computer-implemented method or as a computer program product.

Some embodiments of the present disclosure are now described with reference to the drawings. In the drawings, like referenced numerals are used to refer to like elements throughout. In the following description, for purposes of explanation, numerous specific details are set forth in order to provide a more thorough understanding of the embodiments. In various cases, some embodiments may be practiced without these specific details, yet a person having ordinary skill in the art will recognize that such embodiments are within metes and bounds of this disclosure.

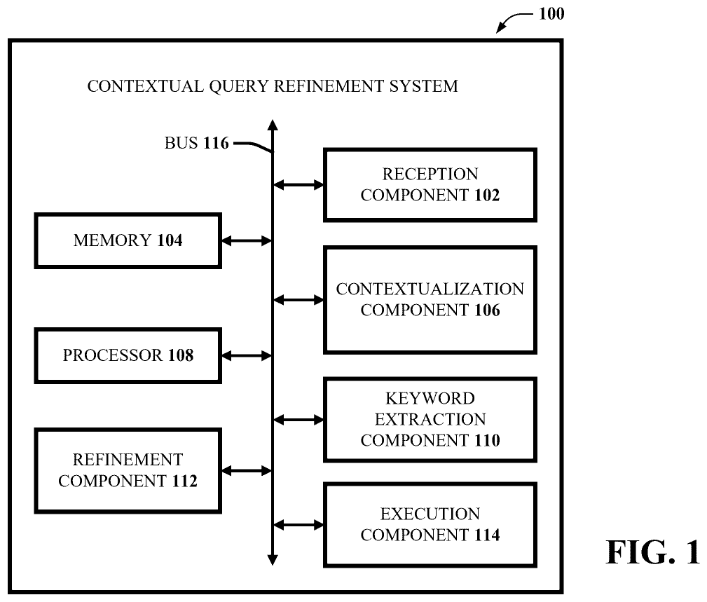

FIG. 1 illustrates an example system 100 for facilitating contextual query refinement for retrieval-augmented generation. System 100 uses a reception component 102, a contextualization component 106, keyword extraction component 110, refinement component 112, and an execution component 114. The reception component receives a query. The contextualization component contextualizes the query by identifying context of the query and summarizing background information of the query. The keyword extraction component uses a natural language processor to identify keywords of the contextualized query. The refinement component generates a new query based at least in part on the summarized background information and the extracted keywords. The execution component uses a retrieval-augmented generation system to run the new query.

Aspects of systems (e.g., systems 100, 200, and the like), apparatuses, or processes in various embodiments of the present disclosure can constitute one or more machine-executable components embodied within one or more machines. For example, the components may be embodied in one or more computer readable mediums (or media) associated with one or more machines. Such components, when executed by one or more machines (e.g., computers, computing devices, virtual machines, etc.) can cause the machines to perform the operations described. System 100 may comprise a reception component 102, a memory 104, a contextualization component 106, a processor 108, a keyword extraction component 110, a refinement component 112, an execution component 114, and a system bus 116.

The system 100 and/or the components of the system 100 can use hardware and/or software to solve problems that are highly technical in nature. System 100 solves problems that are not abstract and that cannot be performed as a set of mental acts by a human. Further, some of the processes may be performed by specialized computers for carrying out defined tasks related to recovery plan development. The system 100 and/or components of the system 100 can be employed to solve new problems that arise through advancements in technologies. The system 100 can provide technical improvements to the retrieval-augmented generation process by increased retrieval access, reduced information overload, and enhanced response quality.

System 100 may include a processor 108. In some embodiments, the processor 108 can execute a component or subcomponent associated with the system 100. Components or subcomponents associated with the system 100 can include one or more machine readable, writable, and/or executable instructions. In some embodiments, the system 100 can include a memory 104, and the memory 104 can store one or more components and/or subcomponents associated with the system 100. In some embodiments, the processor 108 can execute a component stored in the memory 104.

In some embodiments, the system 100 can include a computer-readable memory 104 that can be operably connected to the processor 108. The memory 104 can store computer-executable instructions that, upon execution by the processor 108, may cause the processor 108 and/or one or more other components of the system 100 (e.g., the reception component 102, the contextualization component 106, the keyword extraction component 110, the refinement component 112, and/or the execution component 114) to perform one or more actions. In some embodiments, the memory 104 can store computer-executable components e.g., the reception component 102, the contextualization component 106, the keyword extraction component 110, the refinement component 112, and/or the execution component 114).

The system 100 and/or a component thereof as described herein can be communicatively, electrically, operatively, optically, and/or otherwise coupled to one another via a bus 116. The bus 116 can include one or more of a memory bus, memory controller, peripheral bus, external bus, local bus, and/or another type of bus that can employ one or more bus architectures. In some embodiments, the system 100 can be coupled (e.g., communicatively, electrically, operatively, optically, and/or the like) to one or more external systems (e.g., an electrical output production system, one or more output targets, an output target controller, and/or the like). In some embodiments, the system 100 can be coupled to one or more external sources, and/or devices (e.g., classical computing devices, communication devices, and/or like devices), such as via a network. In some embodiments, one or more of the components of the system 100 can reside in the cloud and/or locally in a local computing environment (e.g., at one or more specified locations).

In addition to the processor 108 and/or the memory 104 described above, the system 100 can include one or more computer and/or machine readable, writable, and/or executable components and/or instructions. When executed by the processor 108, these components and/or instructions can enable performance of one or more operations defined by the component(s) and/or instruction(s).

In various embodiments, the reception component 102 receives a query. Reception component 102 can further comprise a prompt template mechanism that includes one or more placeholders.

According to some embodiments, the contextualization component 106 contextualizes the query by identifying a context of the query and summarizing background information of the query. Contextualization component 106 can distinguish the query from contextual knowledge and remove extraneous background information. Furthermore, contextualization component 106 can identify the core question pertaining to the query.

In various embodiments, the keyword extraction component 110 can use a natural language processor to identify keywords of the contextualized query. Keyword extraction component 110 can utilize surrounding background information to mine essential keywords.

Refinement component 112 can generate a new query based at least in part on the summarized background information and the extracted keywords. The refinement component 112 can further comprise a generative transformer model that reformulates the query. Upon identifying the core question pertaining to the query, the refinement component 112 can generate a new query at least in part by blending the core question with the summarized information or extracted keywords. Upon generating a new query, the refinement component 112 can utilize a generative model to blend the core question with summarized information or extracted keywords.

Execution components 114 uses a retrieval-augmented generation system to run the new query.

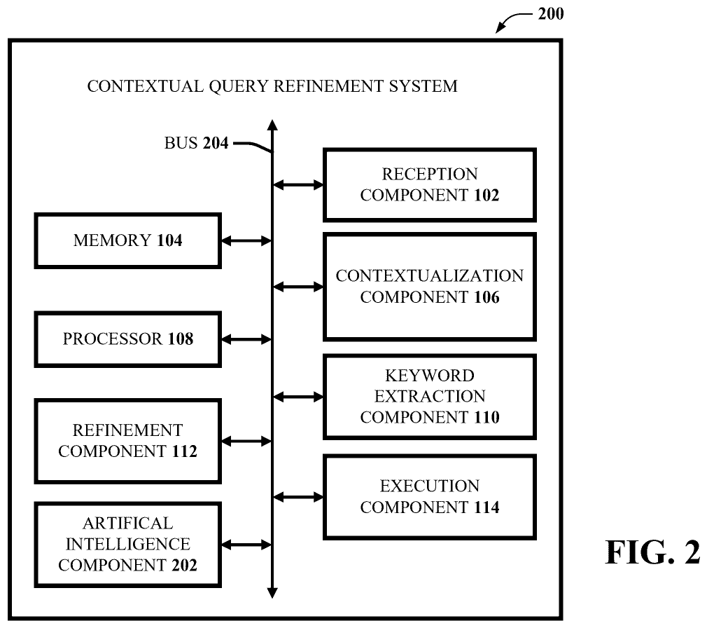

FIG. 2 illustrates an example system 200 that can facilitate contextual query refinement for retrieval-augmented generation. System 200 uses reception component 102, contextualization component 106, keyword extraction component 110, refinement component 112, execution component 114, and an artificial intelligence component 202. The reception component receives a query. The contextualization component contextualizes the query by identifying context of the query and summarizing background information of the query. The keyword extraction component uses a natural language processor to identify keywords of the contextualized query. The refinement component generates a new query based at least in part on the summarized background information and the extracted keywords. The execution component uses a retrieval-augmented generation system to run the new query. The artificial intelligence component 202 trains an artificial intelligence model to generate a new query. Description of like components has been omitted for the sake of brevity.

According to some embodiments, the artificial intelligence component 202 can train an artificial intelligence model on the contextualized query and the extracted keywords to generate a new query to generate a new query.

The systems and/or devices are described herein with respect to interaction between one or more components. Such systems and/or components can include the components and/or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity but known by those of skill in the art.

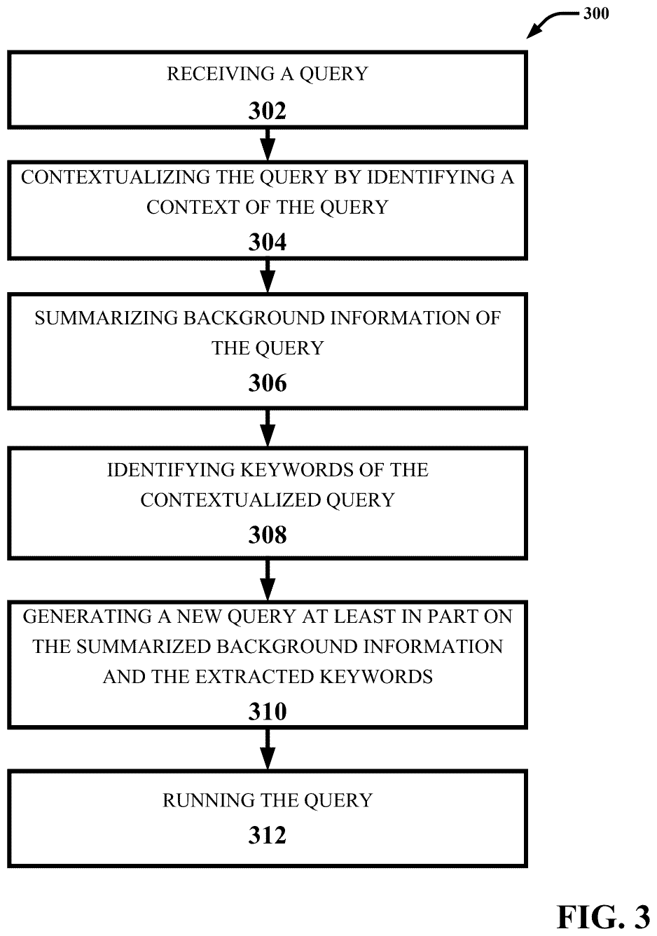

Next, FIG. 3 illustrates a flow diagram of a method 300 that can facilitate contextual query refinement for retrieval-augmented generation in accordance with some embodiments described herein, such as the system 200 of FIG. 2 and the system 100 of FIG. 1. While the method 300 is described relative to the system 200 of FIG. 2, the method 300 can be applicable also to other systems described herein. Repetitive description of like elements and/or processes employed in respective embodiments is omitted for sake of brevity.

For simplicity of explanation, the computer-implemented methods provided herein are depicted and/or described as a series of actions. It is to be understood that the subject matter is not limited by the actions illustrated and/or by the order thereof. For example, actions can occur in one or more orders, concurrently, and/or with other acts not presented and described herein. Furthermore, not all illustrated actions can be utilized to implement the computer-implemented methods in accordance with the described subject matter. In addition, the computer-implemented methods could alternatively be represented as a series of interrelated states via a state diagram or events. Additionally, the computer-implemented methods described in this specification are capable of being stored on an article of manufacture to facilitate transporting and transferring the computer-implemented methods to computers. The term article of manufacture, as used herein, encompasses a computer program accessible from any computer-readable device or storage media.

At 302, the method 300 includes receiving a query. The method 300 can use a system operatively coupled to the processor (e.g., reception component 102) to receive the query.

At 304, method 300 includes contextualizing the query by identifying context of the query. The method 300 can use a system operatively coupled to the processor (e.g., contextualization component 106) to identify the context of the query. Identifying the context of the query can allow for the retrieval system to understand the query's background, intent, and nuances.

At 306, method 300 includes summarizing background information of the query. The method 300 can use a system operatively coupled to the processor (e.g., contextualization component 106) to summarize background information of the query. By summarizing the background information, the retrieval system can help understand the broader context. This can allow for the system to filter out irrelevant data and focus on retrieving content that directly addresses the specific needs of the query.

At 308, method 300 includes identifying keywords of the contextualized query. The method 300 can use a system operatively coupled to the processor (e.g., keyword extraction component 110) to identify keywords of the contextualized query. This mechanism can leverage the capabilities of smaller-scale natural language processor models, such as BERT or T5. Keywords can be identified from streamlined input data, such as log files, indexed information, or other collections of background information that might be relevant to the refined query. The chosen natural language processor model can use a mechanism called “attention” to weigh the importance of words or phrases in each piece of text. By exploiting this feature, these models can navigate and interpret the semantic meaning within extensive bodies of text. Their ability to comprehend and contextualize each given word based on the overall textual content around it can enable these models to extract high-value keywords that may be crucial to the broader meaning of the query. This keyword extraction process is focused and deliberate, mainly homing in on the key elements of the background data that pertain to the reformulated user query. By strategically utilizing the representative power of smaller-scale the results can be markedly accurate, contextually aware keywords that can significantly enhance query formulation and subsequent knowledge retrieval.

At 310, method 300 includes generating a new query at least in part on the summarized background information and the extracted keywords. The method 300 can use a system operatively coupled to the processor (e.g., refinement component 112) to generate the new query.

At 312, method 300 includes running the query. The method 300 can use a system operatively coupled to the processor (e.g., execution component 114) to run the query. The refined query can be forwarded to a retrieval-augmented generation system for analysis, creating a cohesive mechanism for accurate knowledge retrieval and response generation.

In some embodiments, method 300 is performed by a system, such as system 100 of FIG. 1 or system 200 of FIG. 2. The receiving a query 302 can be performed by a reception component (e.g., reception component 102 of FIG. 2). The contextualizing the query by identifying context of the query 304 can be performed by a contextualization component (e.g., contextualization component 106). Summarizing background information of the query 306 can be performed by a contextualization component (e.g., contextualization component 106). The identifying keywords of the contextualized query 308 can be performed by a keyword extraction component (e.g., keyword extraction component 110). Generating a new query at least in part on the summarized background information and the extracted keywords 310 can be performed by a refinement component (e.g., refinement component 112). Running the query 312 can be performed by an execution component (e.g., execution component 114).

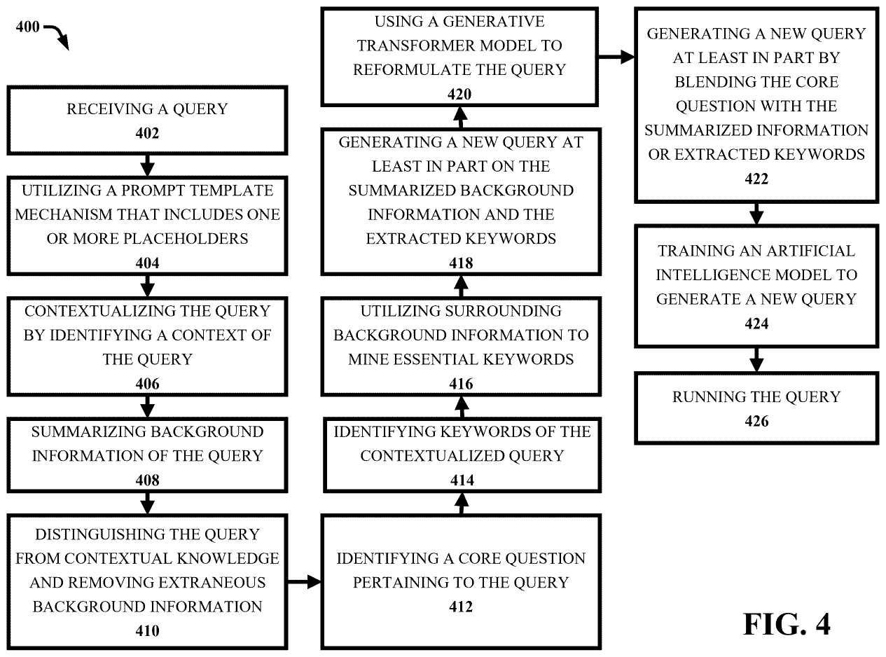

Next, FIG. 4 illustrates a flow diagram of a method 400 that can facilitate contextual query refinement for retrieval-augmented generation in accordance with some embodiments described herein. While the method 400 is described relative to the system 200 of FIG. 2, the method 400 can be applicable also to other systems described herein, such as the system 100 of FIG. 1.

At 402, the method 400 includes receiving a query. The method 400 can use a system operatively coupled to the processor (e.g., reception component 102) to receive the query.

At 404, method 400 includes utilizing a prompt template mechanism that includes one or more placeholders. The method 400 can use a system operatively coupled to the processor (e.g., reception component 102) to use the prompt template mechanism. The prompt template mechanism can use a predefined structure or format for queries designed to guide input in a consistent way. The prompt templating can operate within a RAG-based toolset, such as Langchain. Using this mechanism can distinguish the inherent question from the contextual knowledge, effectively reducing informational clutter and focusing on the essential query. This mechanism can utilize artificial intelligence principles, so that the system can understand and interpret the user's input intelligently rather than merely performing a lexical analysis. As a result, the exact scope of the question can be identified while eliminating any extraneous background information. This intelligent filtration process can declutter the input data by focusing on the essential query parameters and subsequently can improve the efficiency of subsequent search and retrieval processes.

At 406, method 400 includes contextualizing the query by identifying context of the query. The method 400 can use a system operatively coupled to the processor (e.g., contextualization component 106) to identify the context of the query. Identifying the context of the query can allow for the retrieval system to understand the query's background, intent, and nuances.

At 408, method 400 includes summarizing background information of the query. The method 400 can use a system operatively coupled to the processor (e.g., contextualization component 106) to summarize background information of the query. By summarizing the background information, the retrieval system can help understand the broader context. This can allow for the system to filter out irrelevant data and focus on retrieving content that directly addresses the specific needs of the query.

At 410, method 400 includes distinguishing the query from contextual knowledge and removing extraneous background information. The method 400 can use a system operatively coupled to the processor (e.g., reception component 102, contextualization component 106) to distinguish the query from contextual knowledge and remove extraneous background information. By distinguishing the query, the retrieval system can focus on the core question and can reduce irrelevant data.

At 412, method 400 includes identifying a core question pertaining to the query. The method 400 can use a system operatively coupled to the processor (e.g., reception component 102, contextualization component 106) to identify the core question of the query.

At 414, method 400 includes identifying keywords of the contextualized query. The method 400 can use a system operatively coupled to the processor (e.g., keyword extraction component 110) to identify keywords of the contextualized query. This mechanism can leverage the capabilities of smaller-scale natural language processor models, such as BERT or T5. Keywords can be identified from streamlined input data, such as log files, indexed information, or other collections of background information that might be relevant to the refined query. The chosen natural language processor model can use a mechanism called “attention” to weigh the importance of words or phrases in each piece of text. By exploiting this feature, these models can navigate and interpret the semantic meaning within extensive bodies of text. Their ability to comprehend and contextualize each given word based on the overall textual content around it can enable these models to extract high-value keywords that may be crucial to the broader meaning of the query. This keyword extraction process is focused and deliberate, mainly homing in on the key elements of the background data that pertain to the reformulated user query. By strategically utilizing the representative power of smaller-scale the results can be markedly accurate, contextually aware keywords that can significantly enhance query formulation and subsequent knowledge retrieval.

At 416, method 400 includes utilizing surrounding background information to mine essential keywords. The method 400 can use a system operatively coupled to the processor (e.g., keyword extraction component 110) to utilize surrounding background information to mine essential keywords.

At 418, method 400 includes generating a new query at least in part on the summarized background information and the extracted keywords. The method 400 can use a system operatively coupled to the processor (e.g., refinement component 112) to generate the new query.

At 420, method 400 includes using a generative transformer model to reformulate the query. The method 400 can use a system operatively coupled to the processor (e.g., refinement component 112, artificial intelligence component 202) to reformulate the query.

At 422, method 400 includes generating a new query at least in part by blending the core question with the summarized information or extracted keywords. The method 400 can use a system operatively coupled to the processor (e.g., refinement component 112, artificial intelligence component 202) to generate the new query. During the reformulation process, the generative transformer model can take the core question and blend it with the critically important keywords that have been extracted. The reformulation process can hold onto the essence of the original inquiry while ensuring the query is comprehensive in its scope and concisely worded.

At 424, method 400 includes generating a new query at least in part on the summarized background information and the extracted keywords. The method 400 can use a system operatively coupled to the processor (e.g., refinement component 112, artificial intelligence component 202) to generate the new query.

At 426, method 400 includes running the query. The method 400 can use a system operatively coupled to the processor (e.g., execution component 114) to run the query. The refined query can be forwarded to a retrieval-augmented generation system for analysis, creating a cohesive mechanism for accurate knowledge retrieval and response generation.

One or more systems, devices, computer program products, and/or computer-implemented methods provided herein relate to contextual query refinement for retrieval-augmented generation. A system can include a processor that executes computer executable components stored in memory. The computer executable components can include a reception component that receives a query. The computer executable components can further include a contextualization component that contextualizes the query by identifying context of the query and summarizing background information of the query. The computer executable components can further include a keyword extraction component that uses a natural language processor to identify keywords of the contextualized query. The computer executable components can include refinement component that generates a new query based at least in part on the summarized background information and the extracted keywords. The computer executable components can further include an execution component that uses a retrieval-augmented generation system to run the new query.

Advantages of this system can include increased retrieval access, reduced information overload, and enhanced response quality.

In some embodiments of the aforementioned system, the reception component receives a query. Reception component 102 can further comprise a prompt template mechanism that includes one or more placeholders.

According to some embodiments, the contextualization component contextualizes the query by identifying a context of the query and summarizing background information of the query. Contextualization component can distinguish the query from contextual knowledge and remove extraneous background information. Contextualization component 106 can identify the core question pertaining to the query.

In various embodiments, the keyword extraction component can use a natural language processor to identify keywords of the contextualized query. The keyword extraction component can utilize surrounding background information to mine essential keywords.

Refinement component can generate a new query based at least in part on the summarized background information and the extracted keywords. The refinement component can further comprise a generative transformer model that reformulates the query. Upon identifying the core question pertaining to the query, the refinement component can generate a new query at least in part by blending the core question with the summarized information or extracted keywords. Upon generating a new query, the refinement component can utilize a generative model to blend the core question with summarized information or extracted keywords.

Execution components can use a retrieval-augmented generation system to run the new query.

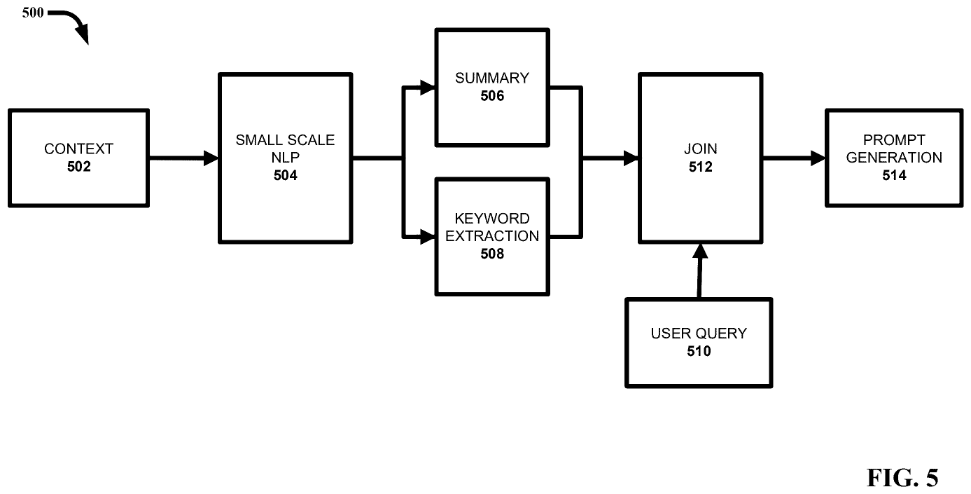

FIG. 5 illustrates an example flow diagram that can facilitate contextual query refinement for retrieval-augmented generation in accordance with some of the embodiments described herein. At 502, the context of the query is identified. At 504, the context of the query can be processed by a small-scale natural language processor. The natural language processor 504 can extract critical keywords from encompassing background information, such as log files or indexed data. This focused extraction technique can use the transformer architecture of a model, leveraging the understanding semantic meanings and exploiting it to identify the key elements of the input data. The small-scale natural language processor can produce extracted keywords 508 and/or a summary of the query 506. The summary of the query 506 can include the identified core query. Having identified the critical keywords and the summary of the query, a generative transformer model can be engaged 512. Employing its advantages in language semantic understanding, the generative transformer model can synergize the original query 510, summary of the query 506, and the identified keywords 508 to reformulate a comprehensive yet concise query string 514. Lastly, the refined query can further be relayed to a structured indexing system that allows large language models to dynamically retrieve relevant information from external data sources, enabling efficient access to specific knowledge without embedding it directly in the model. Through the index store search, the model can retrieve relevant documents or indexed entries matching the refined query. The method described in 500 shows an example solution to information retrieval. It ensures a balance between automated processes and user input, which can elevate search precision.

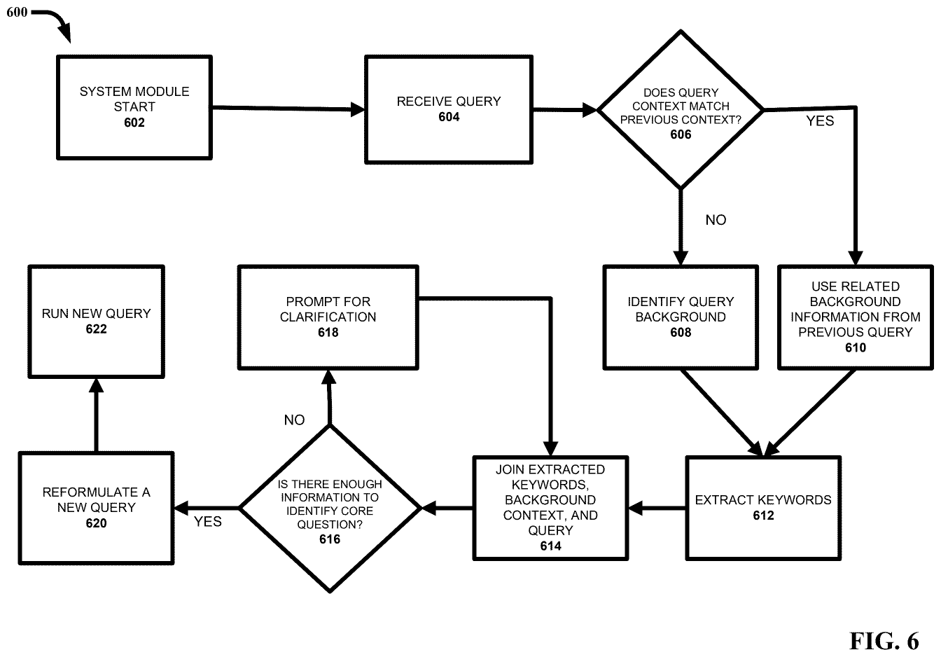

FIG. 6 illustrates a flow diagram of an example query contextualization and refinement system for retrieval-augmented generation in accordance with some of the embodiments described herein. At 602, the system module begins. At 604, the system can receive a natural language query. In some embodiments, the system can utilize a prompt template mechanism to guide input of the query in a consistent way. At 606, the system can determine whether the current query context aligns with that of previous interactions or sessions. If the context is found to be consistent with prior queries 610, the system can incorporate relevant background information from past interactions to support a more informed understanding of the current query. If the context is new or distinct 608, the system can proceed to determine the background information of the query by analyzing related information. Using the summarized background information of the query, the system can identify and extract keywords 612. At 614, the system can combine the extracted keywords, background context, and the original query. At 616, the system can determine if there is enough information to accurately reformulate the query. If additional information is needed, the system can prompt for clarification or further details 618. If there is sufficient information, the system can reformulate a new query 620 and run the new query 622.

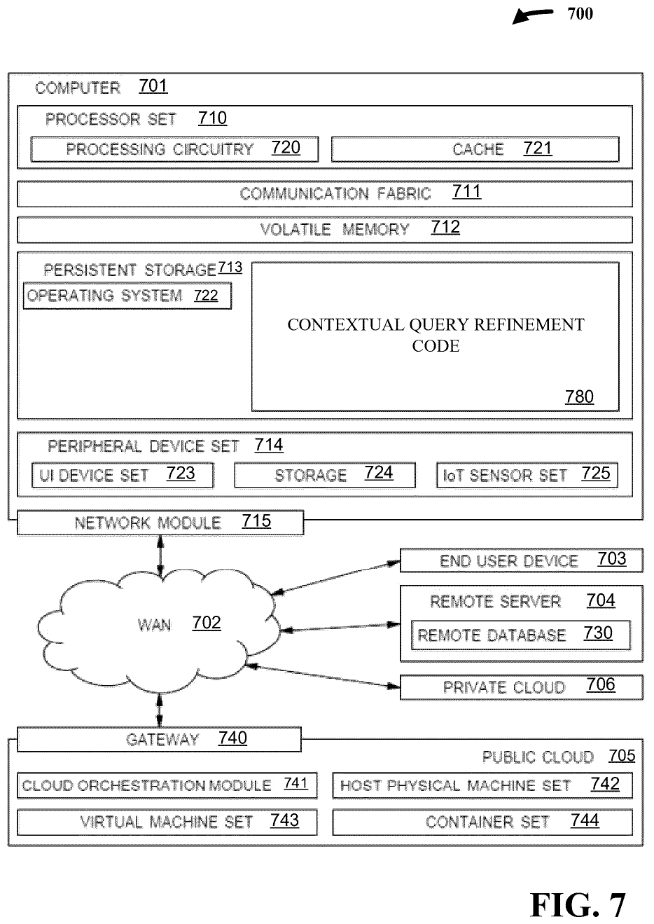

FIG. 7 and the following discussion are intended to provide a brief, general description of a suitable computing environment 700 in which some embodiments described herein can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 700 contains an example of an environment for the execution of at least some of the computer code involved in performing the inventive methods, such as generating a new query based at least in part on the contextualized query and the extracted keywords with contextual query refinement code 780. In addition to block 780, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 745, as identified above), peripheral device set 714 (including user interface (UI), device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method can be distributed among multiple computers and/or between multiple locations. On the other hand, in this presentation of computing environment 700, detailed discussion is focused on a single computer, specifically computer 701, to keep the presentation as simple as possible. Computer 701 can be located in a cloud, even though it is not shown in a cloud in FIG. 7. On the other hand, computer 701 is not required to be in a cloud except to any extent as can be affirmatively indicated.

PROCESSOR SET 710 includes one, or more, computer processors of any type now known or to be developed in the future. Processing circuitry 720 can be distributed over multiple packages, for example, multiple, coordinated integrated circuit chips. Processing circuitry 720 can implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set can be located “off chip.” In some computing environments, processor set 710 can be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods can be stored in block 745 in persistent storage 713.

COMMUNICATION FABRIC 711 is the signal conduction path that allows the various components of computer 701 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 712 is any type of volatile memory now known or to be developed in the future. Examples include dynamic type random access memory (RAM) or static type RAM. Typically, the volatile memory is characterized by random access, but this is not required unless affirmatively indicated. In computer 701, the volatile memory 712 is located in a single package and is internal to computer 701, but, alternatively or additionally, the volatile memory can be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 can be a read only memory (ROM), but typically at least a portion of the persistent storage allows writing of data, deletion of data and re-writing of data. Some familiar forms of persistent storage include magnetic disks and solid-state storage devices. Operating system 722 can take several forms, such as various known proprietary operating systems or open-source Portable Operating System Interface type operating systems that employ a kernel. The code included in block 745 typically includes at least some of the computer code involved in performing the inventive methods.

PERIPHERAL DEVICE SET 714 includes the set of peripheral devices of computer 701. Data communication connections between the peripheral devices and the other components of computer 701 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 723 can include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 can be persistent and/or volatile. In some embodiments, storage 724 can take the form of a quantum computing storage device for storing data in the form of qubits. In embodiments where computer 701 is required to have a large amount of storage (for example, where computer 701 locally stores and manages a large database) then this storage can be provided by peripheral storage devices designed for storing large amounts of data, such as a storage area network (SAN) that is shared by multiple, geographically distributed computers. IoT sensor set 725 is made up of sensors that can be used in Internet of Things applications. For example, one sensor can be a thermometer, and another sensor can be a motion detector.

NETWORK MODULE 715 is the collection of computer software, hardware, and firmware that allows computer 701 to communicate with other computers through WAN 702. Network module 715 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701) and can take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 can be a client device, such as thin client, heavy client, mainframe computer and/or desktop computer.

REMOTE SERVER 704 is any computer system that serves at least some data and/or functionality to computer 701. Remote server 704 can be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data can be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs can be stored as images and can be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware and firmware allowing public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1175 and private cloud 1176 are both part of a larger hybrid cloud. The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of some of the embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of some of the embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In some embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of some of the embodiments described herein.

Aspects of some of the embodiments described herein are described with reference to flowchart illustrations and/or block diagrams of methods, apparatus (systems), and computer program products according to some embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality, and/or operation of possible implementations of systems, computer-implementable methods, and/or computer program products according to some embodiments described herein. In this regard, each block in the flowchart or block diagrams can represent a module, segment, and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that some of the embodiments herein also can be implemented at least partially in parallel with one or more other program modules. Generally, program modules include routines, programs, components, and/or data structures that perform particular tasks and/or implement particular abstract data types. Moreover, the described computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches, and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the various embodiments, but one of ordinary skill in the art can recognize that many further combinations and/or permutations of the various embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a processor that executes computer executable components stored in memory, wherein the computer executable components comprise:
a reception component that receives a query;
a contextualization component that contextualizes the query by identifying a context of the query and summarizing background information of the query;
a keyword extraction component that uses a natural language processor to identify keywords of the contextualized query;
a refinement component that generates a new query based at least in part on the summarized background information and the extracted keywords; and
an execution component that uses a retrieval-augmented generation system to run the new query.

2. The system of claim 1, wherein the reception component further comprises a prompt template mechanism that includes one or more placeholders.

3. The system of claim 1, wherein the contextualization component distinguishes the query from contextual knowledge and removes extraneous background information.

4. The system of claim 1, wherein the keyword extraction component utilizes surrounding background information to mine essential keywords.

5. The system of claim 1, wherein the refinement component further comprises a generative transformer model that reformulates the query.

6. The system of claim 1, further comprising an artificial intelligence component that trains an artificial intelligence model to generate a new query.

7. The system of claim 1, wherein the identified keywords comprise contextual information.

8. The system of claim 1, wherein the contextualization component further identifies a core question pertaining to the query.

9. The system of claim 8, wherein the refinement component generates a new query at least in part by blending the core question with the summarized information or extracted keywords.

10. The system of claim 9, wherein the refinement component utilizes a generative model to blend the core question with the summarized information or extracted keywords.

11. A computer-implemented method that utilizes a processor that executes computer executable components stored in memory to perform the following acts:
receiving a query;
contextualizing the query by identifying a context of the query;
summarizing background information of the query;
identifying keywords of the contextualized query;
generating a new query based at least in part on the summarized background information and the extracted keywords; and
running the new query.

12. The method of claim 11, further comprising utilizing a prompt template mechanism that includes one or more placeholders.

13. The method of claim 11, further comprising distinguishing the query from contextual knowledge and removing extraneous background information.

14. The method of claim 11, further comprising utilizing surrounding background information to mine essential keywords.

15. The method of claim 11, further comprising using a generative transformer model to reformulate the query.

16. The method of claim 11, further comprising training an artificial intelligence model to generate a new query.

17. The method of claim 11, wherein the identified keywords comprise contextual information.

18. The method of claim 11, further comprising identifying a core question pertaining to the query.

19. The method of claim 18, further comprising generating a new query at least in part by blending the core question with the summarized information or extracted keywords.

20. A computer program product comprising a computer readable storage medium having program instructions embodied therewith, the program instructions executable by a processor to cause the processor to:
receive a query;
contextualize the query by identifying a context of the query;
summarize background information of the query;
identify keywords of the contextualized query;
generate a new query based at least in part on the summarized background information and the extracted keywords; and
run the new query.
